(19) United States
(12) Patent Application Publication
(10) Pub. No.: US 2023/0023624 A1
(43) Pub. Date: Jan. 26, 2023

(54) FILTER CARTRIDGE WITH VALVE MEMBER AND METHODS

(71) Applicant: Donaldson Company, Inc., Bloomington, MN (US)

(72) Inventors: Michael J. Gustafson, Minnetonka, MN (US); Erik P. Anderson, Eagan, MN (US); Brent T. Harrold, Burnsville, MN (US); Robert A. McGlade, Somerset, WI (US); John K. Aune, Eden Prairie, MN (US)

(21) Appl. No.: 17/862,771

(22) Filed: Jul. 12, 2022

Related U.S. Application Data
(60) Provisional application No. 63/223,699, filed on Jul. 20, 2021.

(51) Int. Cl. B01D 35/153; B01D 27/08; B01D 35/30

(52) U.S. Cl. CPC B01D 35/153; B01D 27/08; B01D 35/30; B01D 2201/16; B01D 2201/291; B01D 2201/34

(57) ABSTRACT

A filter cartridge with flow travelling from inside to outside with a flow path in a bottom end cap to enter the cartridge has an anti-drain back valve to prevent cross-contamination to the clean side of the system during filter change-out. The anti-drain back valve moves away from the bottom end cap to allow inlet flow into the cartridge during filtering operation, and when flow ceases, the valve settles to the bottom of the cartridge to plug the flow path during service.

### CROSS-REFERENCE TO RELATED APPLICATION

This application claims the benefit of U.S. Provisional Patent Application No. 63/223,699, filed Jul. 20, 2021, which is incorporated by reference herein in its entirety.

### TECHNICAL FIELD

This disclosure concerns filter cartridges useful in a variety of systems including, for example, hydraulic tanks. In particular, this disclosure concerns filter cartridges with anti-drain back valves and methods of use.

### BACKGROUND

Many hydraulic systems have tanks with filters in the tanks. In such systems, the filters are periodically changed out. During filter change out, it is helpful to keep contamination from getting into the clean hydraulic circuit. Anti-drain back valves are meant to close flow and prevent sediment and dirt captured by the filter from cross contamination.

### SUMMARY

A filter cartridge is provided to improve the prior art.

In an example, a filter cartridge is provided comprising: filter media arranged in a tubular shape defining an open filter interior, the filter media having first and second opposite ends; a first end cap secured to the first end of the filter media; the first end cap having an opening in communication within the open filter interior; a second end cap secured to the second end of the filter media; a central structure in the open filter interior extending away from the first end cap at least partially toward the second end cap; and an unbiased valve member within the open filter interior; the valve member being movable between a first position and a second position; the first position including the valve member covering the opening of the first end cap; and the second position including the valve member being spaced from the first end cap to expose the opening of the first end cap.

In various examples and/or embodiments:
the valve member has a surrounding wall defining a through opening.
the valve member is positioned to be radially constrained by the central structure.
the central structure rests within the through opening of the valve member.
the central structure comprises a flow tube having a tube wall and flow conduit within the tube wall; the flow tube extending to the second end cap.
the valve arrangement includes: first and second opposite valve ends;
and a plate circumscribing and radially extending from the surrounding wall.
the plate is spaced from each of the first valve end and second valve end;
and the plate has a first axial surface and an opposite second axial surface.
the plate is centered between the first valve end and the second valve end.

In some examples or embodiments, there further includes:
a first plurality of gussets extending upward and radially away from the first valve end to the first axial surface.
a second plurality of gussets extending downward and radially away from the second valve end to the second axial surface.

In various examples and/or embodiments:
the valve arrangement has a bulb-shaped member extending from the surrounding wall.
the valve arrangement has a wedge-shaped member extending from the surrounding wall.
or further including a plurality of ribs extending from the wedge-shaped member to the surrounding wall.
the valve arrangement has a torus shaped member extending from the surrounding wall.
or further including an inlet arrangement radially between an outer portion of the flow tube and an inner portion of the filter media.

In various examples and/or embodiments:
the central structure comprises a rigid post.
the rigid post extends from the first end cap less than 50% of a length of the filter cartridge toward the second end cap.
the valve member comprises a non-porous disk having a through-opening; the rigid post being in intimate communication with the through-opening.
the disk includes: (a) an outer rim; and a seal portion.
the disk includes: first and second opposite axial sides; the first axial side facing the first end cap; the first axial side having a circumferential ridge projecting therefrom and spaced radially inboard from the outer rim; and the first axial side having a seal surface defining the seal portion between the outer rim and the ridge.
further including a plurality of ribs on each of the first and second axial sides axially projecting from the first and second axial sides and radially extending from the through-opening.
the valve member includes any one of a bulb seal, wedge seal, or torus-shaped seal.
wherein the first end cap includes: a tray holding the filter media and having an inner tray wall; a central hub in the first end cap opening; and plurality of spokes extending between the hub and the inner tray wall.
the rigid post projects from the central hub into the open filter interior.

In various examples and/or embodiments:
the first end cap includes a tray holding the filter media and having an inner tray wall; and the seal surface of the first axial side engages the inner tray wall.
the filter media comprises pleated media.
the filter media further includes secondary filter media circumscribing the pleated media.
further including a first seal member adjacent the first end cap.
the first end cap holds the first seal member.
the first end cap includes a seal holder extending axially therefrom and having a radial groove holding the first seal member therein.
the radial groove is outwardly extending.
the second end cap has a second end cap seal member.
the second end cap has an outer rim with a radial groove holding a second end cap seal member therein.
the second end cap radial groove is outwardly extending.
the flow tube has a first end adjacent the first end cap; the first end of the flow tube including a flow tube seal member projecting radially therefrom.
the tube seal member projects radially outwardly from the flow tube.
the first end of the flow tube extends axially outwardly from the first end cap.
the flow tube has a second end adjacent to the second end cap.
the second end of the flow tube extends axially outwardly from the second end cap.

In another aspect, an in-tank filter assembly is provided including a tank; and a filter cartridge according to a various aspects above removably sealed within the tank.

A variety of examples of desirable product features or methods are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are explanatory only and are not restrictive of the claimed invention.

### BRIEF DESCRIPTION OF THE DRAWINGS

FIG. 1 is a top perspective view of an embodiment of a filter cartridge, constructed in accordance with principles of this disclosure;

FIG. 2 is bottom perspective view of the filter cartridge of FIG. 1;

FIG. 3 is a top plan view of the filter cartridge of FIG. 1;

FIG. 4 is a bottom plan view of the filter cartridge of FIG. 1;

FIG. 5 is a side elevation view of the filter cartridge of FIG. 1;

FIG. 6 is an exploded perspective view of the filter cartridge of FIG. 1;

FIG. 7 is a cross-sectional view of the filter cartridge of FIG. 1 installed in a tank, the cross-section being taken along the line A-A of FIG. 3;

FIG. 8 is an enlarged view of a portion of the cross-section of FIG. 7, and depicting a valve member in a first position;

FIG. 9 is the view of FIG. 8 and depicting the valve member in a second position;

FIG. 10 is a perspective view of FIG. 8;

FIG. 11 is a perspective view of an embodiment of a valve member useable in the filter cartridge of FIG. 1;

FIG. 12 is a side elevational view of the valve member of FIG. 11;

FIG. 13 is a cross-sectional view of the valve member of FIG. 11, the cross-section being taken along the line 13-13 of FIG. 12;

FIG. 14 is a perspective view of a portion of a cross-section of another embodiment of a filter cartridge, constructed in accordance with principles of this disclosure;

FIG. 15 is a cross-sectional view of the filter cartridge portion of FIG. 14;

FIG. 16 is a schematic cross-section of an alternative seal member used in the above assemblies;

FIG. 17 is a schematic cross-section of another alternative seal member used in the above assemblies;

FIG. 18 is another view of the alternative seal member of FIG. 17;

FIG. 19 is another view of the alternative seal member of FIG. 17; and

FIG. 20 is a schematic cross-section of another alternative seal member used in the above assemblies.

### DETAILED DESCRIPTION

In general, a filter cartridge with flow travelling from inside to outside with a flow path in a bottom end cap to enter the cartridge is provided with an anti-drain back valve to prevent cross-contamination to the clean side of the system during filter change-out. The anti-drain back valve moves away from the bottom end cap to allow inlet flow into the cartridge during filtering operation, and when flow ceases, the valve settles to the bottom of the cartridge to plug the flow path during service.

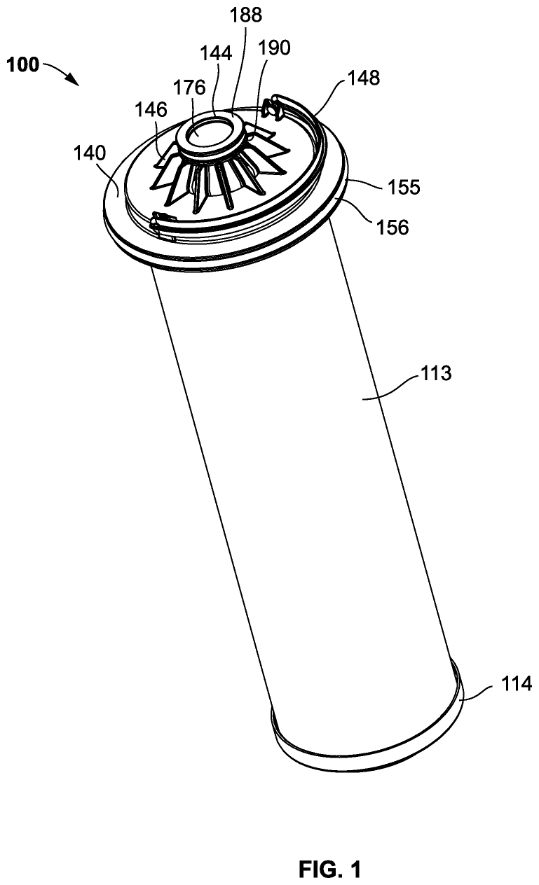

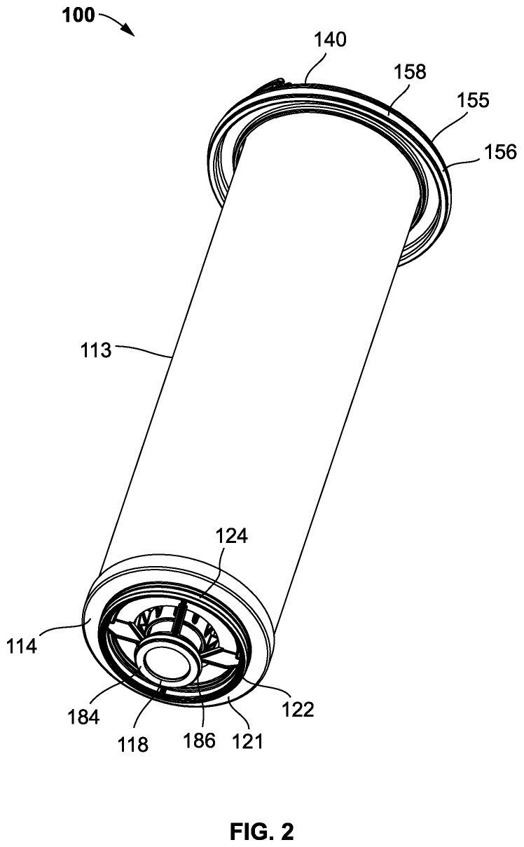

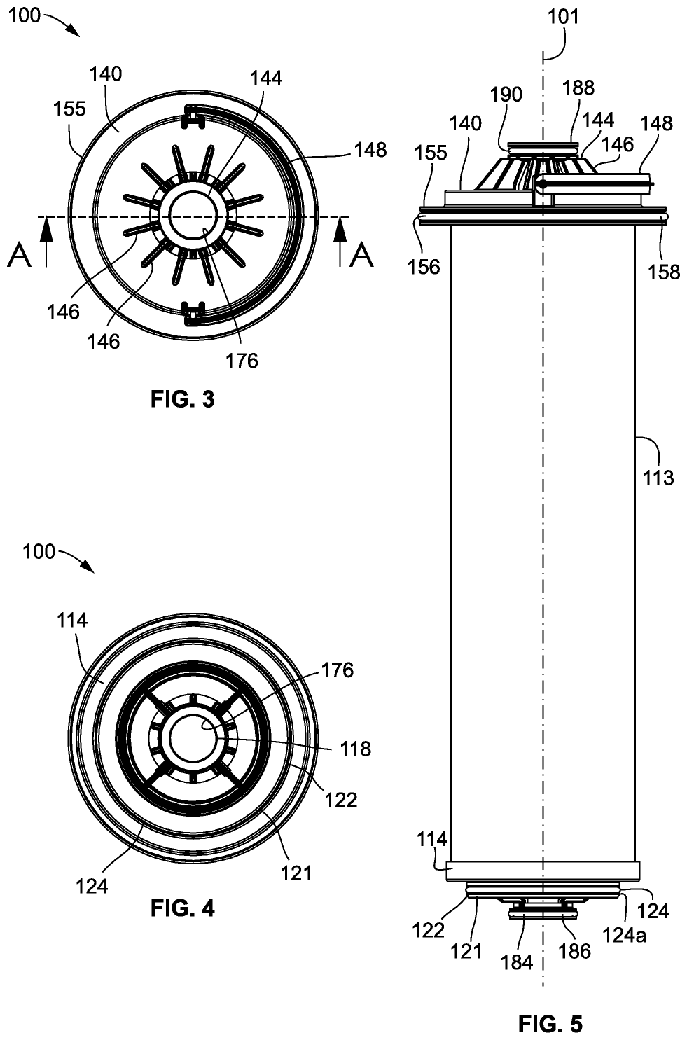

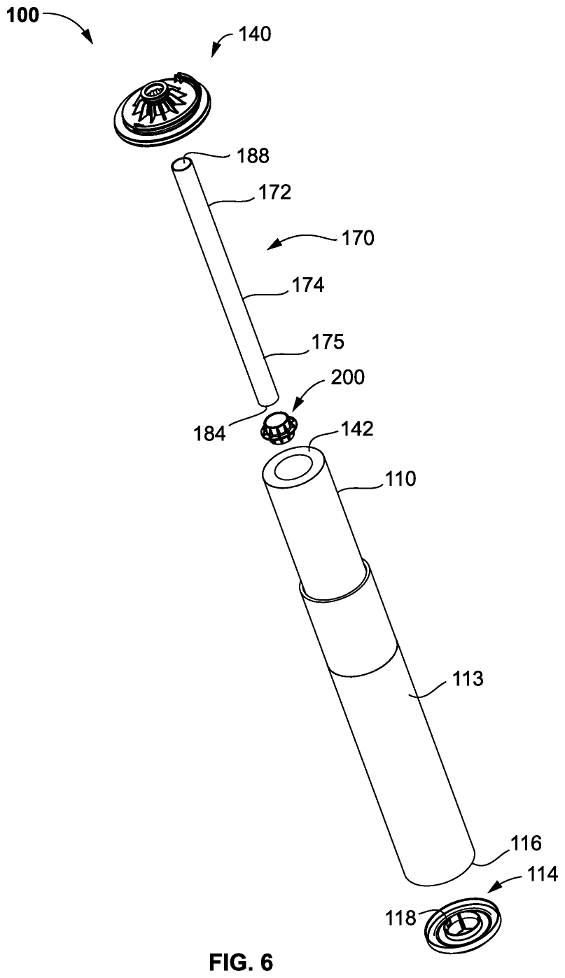

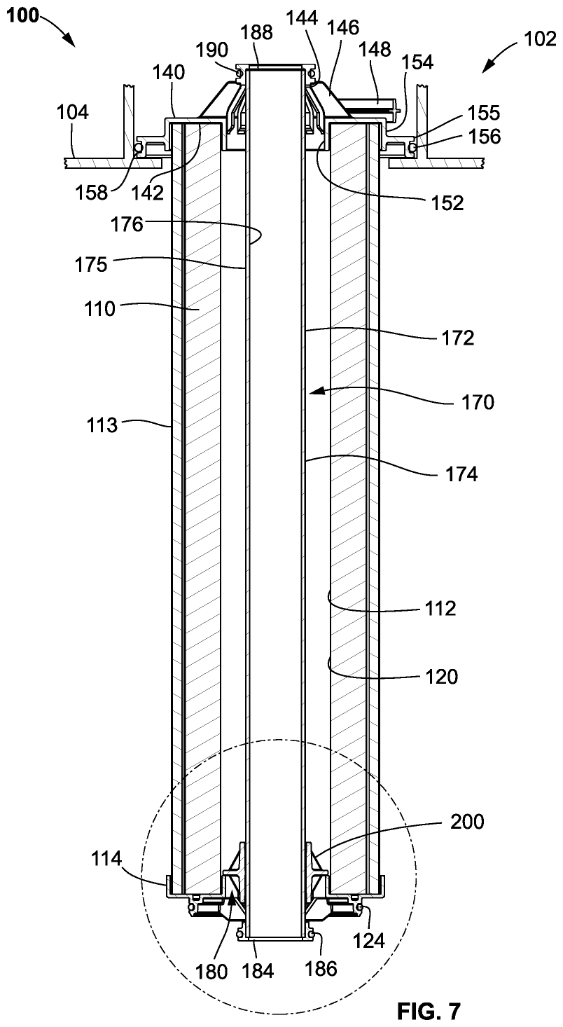

FIGS. 1-7 illustrate an example embodiment of a filter cartridge 100. In one example system, the filter cartridge 100 is used to filter liquid, such as hydraulic liquids. FIG. 7 shows an in-tank filter assembly 102 with the filter cartridge 100 mounted in a tank 104. The filter cartridge 100 may be partially submerged within the fluid in the tank 104. The filter cartridge 100 provides for cleaning of the fluid prior to being conveyed to downstream equipment.

Still in reference to FIGS. 1-7, the filter cartridge 100 has an extension of filter media 110, arranged in this example as a cylinder with an open filter interior 112. Media 110 may be any media sufficient to effectively filter whatever fluid is in the system. The type of media will depend upon what fluid is being filtered, what kind of system the filter is in, and could include other variables. In a typical system, filter media 110 can include a fluted or pleated media. Typically, this may include paper media or cellulose fiber media. Other types of media, including synthetic media, may also be used. The media 110 is arranged in a tubular form. By “tubular”, it is meant that the media 110 is shaped to form a closed loop with an open center, and the closed loop can have a variety of cross-sectional shapes including round, oval, square, rectangular, irregular, etc.

In some example embodiments, the filter cartridge 100 further includes an optional layer of secondary media 113 circumscribing the filter media 110.

A first end cap 114 is secured to a first end 116 of the media 110. First end cap 114 includes an opening 118 to permit access to the filter interior 112, which corresponds to, in the arrangement shown, an unfiltered liquid volume 120. The unfiltered liquid volume 120 is defined, at least in part, by an inner diameter of the filter media 110.

A first seal member 124 can be oriented adjacent to the first end cap 114. Many variations of mounting the first seal member 124 are possible.

In the example shown, the first end cap 114 includes a seal holder 121 in the form of a rigid seal mount 122 projecting axially outwardly from an exterior portion. The term “outwardly” in this context, is meant to refer to a direction of projection away from the media 110. The mount 122 can be formed (for example molded) integral with a remainder of end cap 114. Although alternatives are possible, the example mount 122 shown includes a groove defined by spaced flanges that operate as a mounting space for the seal member 124. Although variants are possible, in the particular example shown, the mount 122 is configured such that the seal 124 is a radially, outwardly, directed form of seal. The particular seal member 124 depicted is an o-ring 124a, although alternatives are possible. The seal member 124 can form a seal with other filter structure, such as an additional filter cartridge or a housing piece.

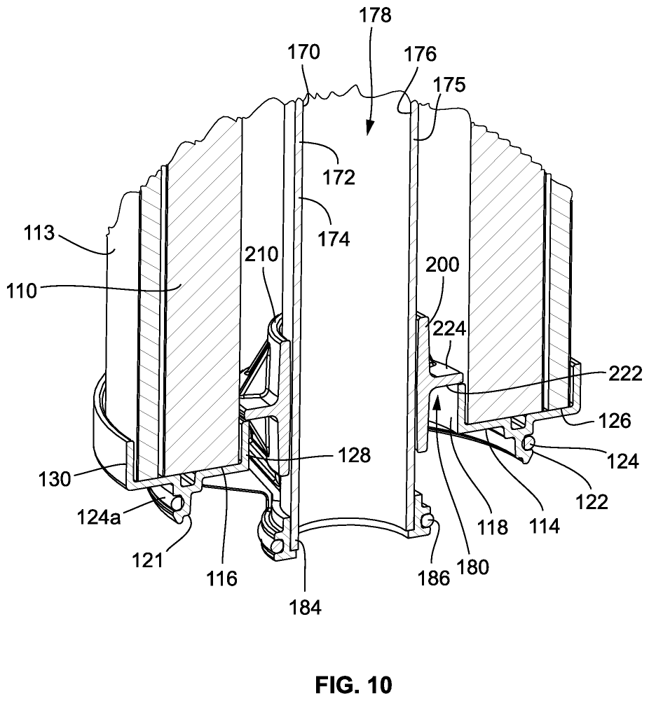

In FIG. 10, the first end cap 114 is shaped as a tray 126 having an inner tray wall 128 and an outer tray wall 130. The first end 116 of the media 110 is contained between the inner tray wall 128 and outer tray wall 130.

A second end cap 140 is secured to a second end 142 of the filter media 110. The second end cap 140 can be closed or have an opening. In the example shown, the second end cap has an opening 144. In this embodiment, the opening 144 accommodates a central structure 170 (discussed further below). In this example, the second end cap 140 has a plurality of gussets 146 projecting axially outwardly from an exterior portion to the opening 144.

The second end cap 140 depicted has an optional handle 148. The handle 148 is secured to the exterior and can be pivoted from the illustrated position of flat against the exterior to a position 90° away from it.

The second end cap 140 is shaped as a tray 150 (FIG. 7) having an inner tray wall 152 and an outer tray wall 154. The second end 142 of the media 110 is contained between the inner tray wall 152 and outer tray wall 154.

In this example, the second end cap 140 has an outer rim 155. In this particular example, the outer rim 155 is radially spaced radially outwardly from the outer tray wall 154.

The second end cap 140 holds a second end cap seal member 156. Many variations are possible. In the example shown, the outer rim 155 has a radial groove 158 holding the second end cap seal member 156 therein. The radial groove 158 is depicted as outwardly extending, but could be inwardly extending. The seal member 156 can form a seal with a cover or a filter head.

The filter cartridge 100 has a central longitudinal axis 101 (FIG. 5) extending between the first end cap 114 and second end cap 140.

The filter cartridge 100 further includes central structure 170 in the open filter interior 112 extending away from the first end cap 114 at least partially in extension toward the second end cap 140.

While many embodiments are possible, in the embodiment of FIGS. 1-10, the central structure 170 comprises a flow tube 172. The flow tube 172 has a tube wall 174 formed in a tube shape, meaning any closed loop (such as a cylinder, but does not need to be a cylinder; it could be oval, square, rectangular, polygonal, or irregular shaped). The tube wall 174 surrounds an interior 176, functioning as a flow conduit 178. In this example, the flow tube 172 extends to the second end cap 140.

In reference now to FIGS. 7-9, an inlet arrangement 180 is defined in the opening 118 of the first end cap 114 radially between an outer portion of the flow tube 172, e.g. the tube wall 174, and an inner portion of the media 110. In the example shown, the inlet arrangement 180 is between the inner tray wall 128 of the first end cap 114 and an outer portion of the tube wall 174.

The flow tube 172 is provided to convey fluid, such as bypass flow, within the conduit 178. Alternatives are possible.

In this example, the flow tube 172 has a first end 184 adjacent the first end cap 114. The first end 184 of the flow tube 172 has a flow tube seal member 186. Many variations are possible, and in the example shown, the flow tube seal member 186 projects radially therefrom, but it could also be an axial seal or other methods, such as potting. In one example, the seal member 186 projects radially outward from the flow tube 172. The seal member 186 can form a seal with other structure, such as additional filter cartridges or housings. In embodiments that do not have flow tube 172, there is no seal member 186.

As can be seen in FIGS. 7-9, the first end 184 of the flow tube 172 extends axially outwardly from the first end cap 114. Alternatives are possible.

The flow tube 172 has a second end 188 adjacent the second end cap 140. The second end 188 is shown extending axially outwardly from the second end cap 140, but it could be even with, or extending axially inwardly from the second end cap 140. The second end 188 of the flow tube 172 has a flow tube seal member 190. While there can be many alternatives, including radially inward or axial, in the example shown, the flow tube seal member 190 projects radially therefrom. In the example shown, the seal member 190 projects radially outward from the flow tube 172. The seal member 190 can form a seal with a filter head or housing structure.

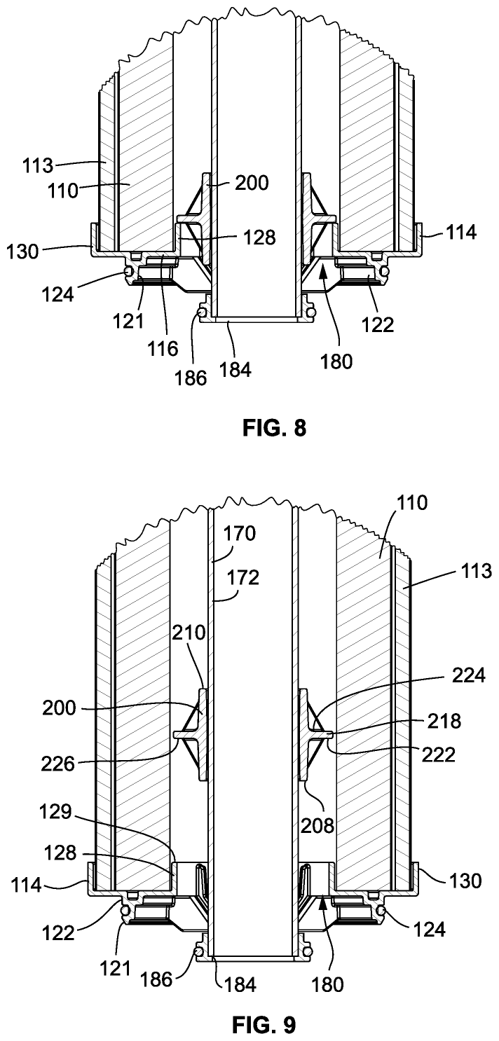

In accordance with principles of this disclosure, the filter cartridge 100 includes a valve member 200. The valve member 200 is positioned within the open filter interior 112. The valve member 200 is movable between a first position (FIG. 8) and a second position (FIG. 9) in response to a pressure differential in the open filter interior 112. The valve member 200 is positioned within the open filter interior 112 unbiased. By “unbiased”, it is meant that there is no other structure (springs, other biasing members) holding the valve member 200 in any position.

In one example, the first position (FIGS. 8 and 10) includes the valve member 200 covering the opening 118 of the first end cap 114. In particular, the valve member 200 covers or blocks the inlet arrangement 180.

In one example, the second position (FIG. 9) includes the valve member 200 spaced from the first end cap 114 to expose the opening 118 of the first end cap 114. In particular, the valve member 200 exposes the inlet arrangement 180 to allow the flow of fluid therethrough.

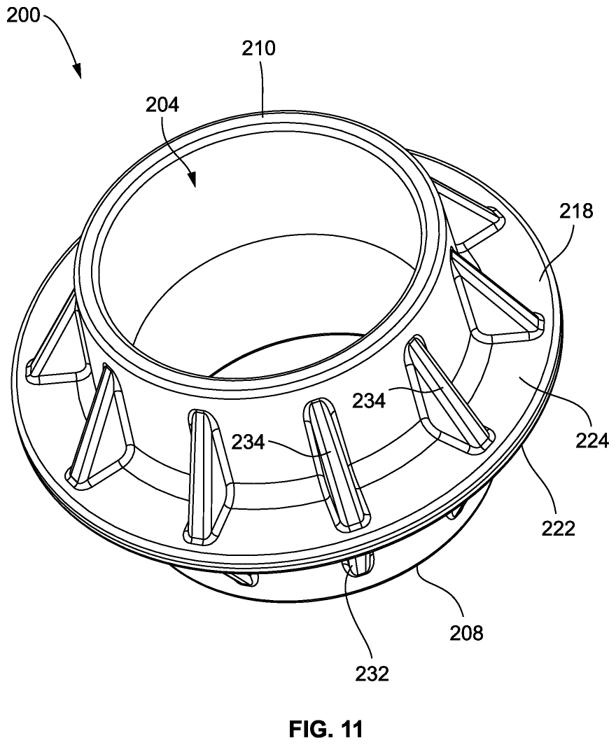

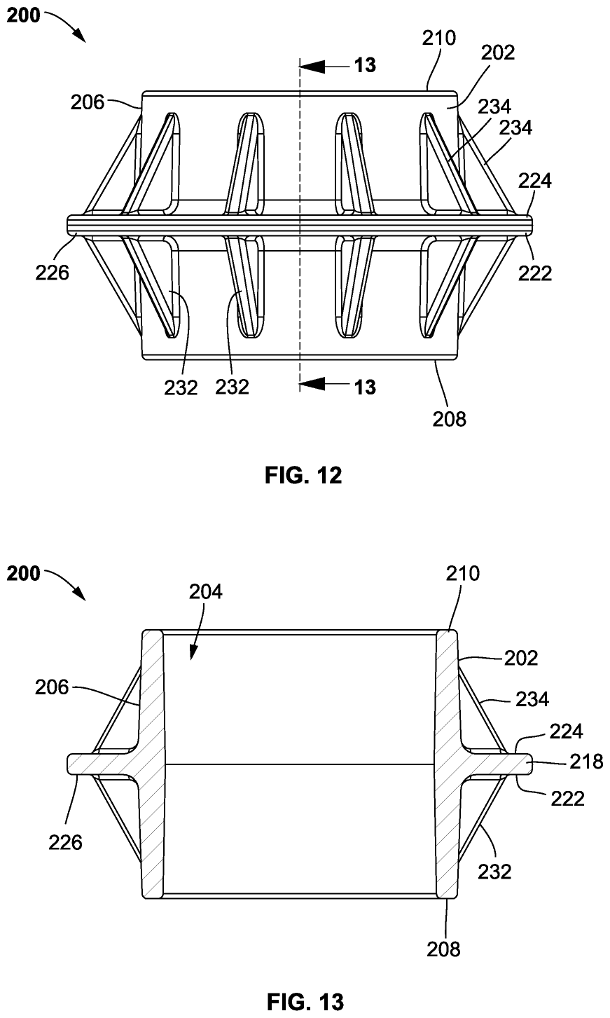

In an example implementation, and in reference now to FIGS. 11-13, an embodiment of the valve member 200 is illustrated. In this example, the valve member 200 is annular, or ring shaped. The valve member 200 has a surrounding wall 202 defining a through opening 204. The surrounding wall 202 can be generally cylindrical in shape to form a ring 206 having a first valve end 208 and an opposite second valve end 210.

The valve member 200 is positioned to be radially constrained by the central structure 170. By “radially constrained”, it is meant that the central structure 170 prevents movement of the valve member 200 in a radial direction. By “radial direction”, it is meant a direction orthogonal to the longitudinal axis 101 (FIG. 5).

In the example shown, the valve member 200 is positioned to be in intimate communication with the central structure 170, such that the central structure 170 rests within the through opening 204 of the valve member 200. By comparing FIG. 8 and FIG. 9, it can be appreciated that the valve member 200 is free to move (for example, slide) relative to an exterior surface 175 of the flow tube 172. The through opening 204 of the valve member 200 has a size only slightly larger than the outer diameter of the flow tube 172, so that it may move relative to it, but not create a flow path between the valve member 200 and the exterior 175 of the flow tube 172, while allowing some leakage therebetween.

Still in reference to FIGS. 11-13, in this example, the valve member 200 includes a plate 218 circumscribing and radially extending from the surrounding wall 202. The plate 218 is spaced from each of the first valve end 208 and second valve end 210. For example, the plate 218 can be centered between the first valve end 208 and second valve end 210. In one example, the valve member 200 is symmetrical, and can be assembled within the filter cartridge 100 with either the first valve end 208 down and second valve end 210 up, or vice-versa with the first valve end 208 up and second valve end 210 down. The plate 218 can be sized to have an outer diameter generally only slightly smaller than an inner diameter of the media 110.

The plate 218 has a first axial surface 222 and an opposite second axial surface 224. The first axial surface 222 faces the first valve end 208 and first end cap 114. The second axial surface 224 faces the second valve end 210 and the second end cap 140.

The first axial surface 222 forms a seal surface 226 to cover the inlet arrangement 180 and form a seal to prevent flow from the filter interior 112 and the unfiltered liquid volume 120. This will prevent cross-contamination to the clean side of the system during filter change-out. The valve 200 settles to the bottom of the cartridge 100 to substantially close the flow path 180 during service. By “substantially close”, it is meant that an intentional leak path is permitted to prevent excessive suction. In this example, and as can be seen in FIG. 9, the seal surface 226 of the first axial surface 222 engages against a terminal end 129 of the inner tray wall 128 to block the flow path 180.

Referring again to FIGS. 11-13, in this example, the valve 200 optionally includes a first plurality of gussets 232 extending upward and radially away from the first valve end 208 to the first axial surface 222. The gussets 232 can provide strength to the valve 200.

The valve 200 optionally includes a second plurality of gussets 234 extending downward and radially away from the second valve end 210 to the second axial surface 224. The gussets 234 can provide strength to the valve 200.

The valve member 200 is constructed of a material having a specific density greater than that of the fluid (such as hydraulic oil) being filtered. This ensures that the valve member 200 sinks in the fluid when there is no filtering operation. During filtering operation, the pressure differential will push the valve member 200 away from the inlet arrangement 180. The valve member 200 is free to move along the exterior surface 175 of the flow tube 172. The valve member 200 can move to the second end cap 140 and against the plurality of gussets 146 in the opening 144 of the second end cap 140. Full flow is permitted between the valve member 200 and the opening 144 of the second end cap 140 to allow for, for example, bypass flow. During servicing, when flow through the cartridge 100 stops, the valve member 200 sinks to the bottom of the cartridge 100 to block the flow path 180.

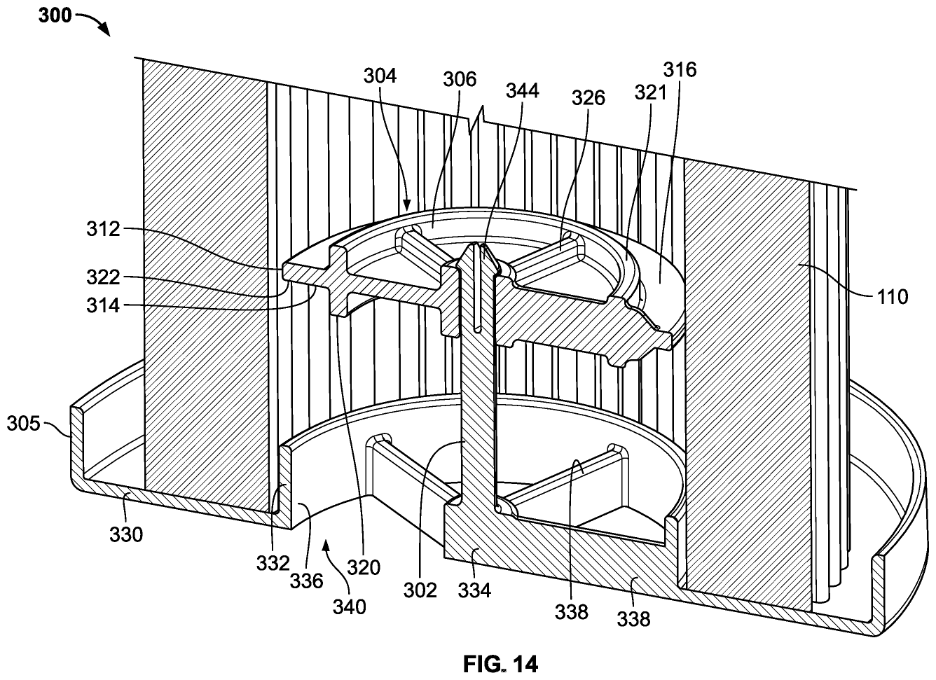

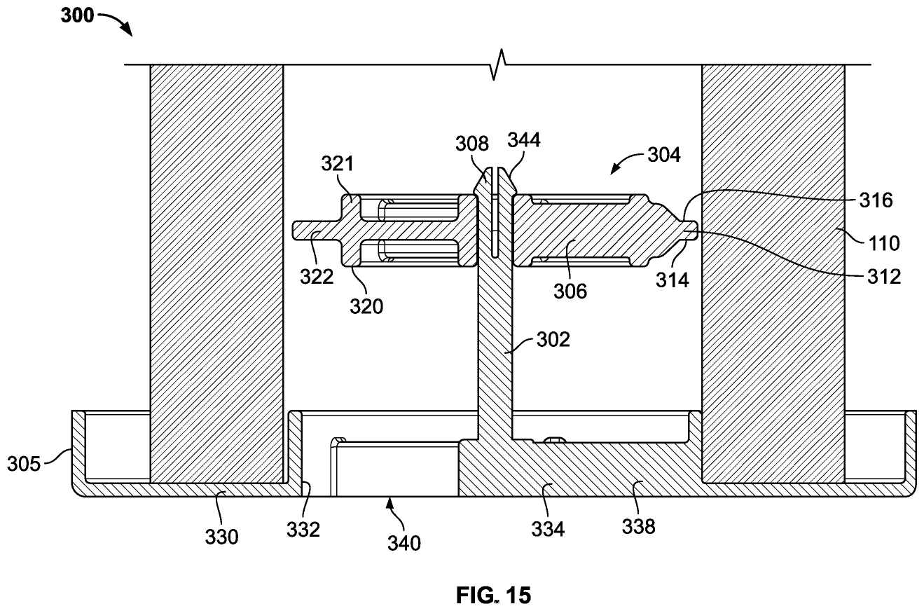

In reference now to FIGS. 14 and 15, a second embodiment of a filter cartridge 300 is illustrated. Some features are in common with the first embodiment of FIGS. 1-13 and have the same reference numbers. In this embodiment, the central structure 170 comprises a rigid post 302. A valve member 304 is shown engaging the rigid post 302.

In an example, the rigid post 302 extends from a first end cap 305 only partially toward the second end cap 140. For example, the rigid post 302 extends from the first end cap 305 less than 50% of a length of the filter cartridge 300 toward the second end cap 140. In other embodiments, the post 302 could extend a full length of the cartridge 300 between the first end cap 305 and second end cap 140.

The valve member 304 comprises a non-porous disk 306 having a through-opening 308. The rigid post 302 is in intimate communication with the through-opening 308. The through opening 308 is sized to allow the valve member 304 to freely move (slide) along the post 302.

In this example embodiment, the disk 306 includes an outer rim 312. The outer rim 312 is sized to be just slightly smaller than the inner diameter of the media 110. The disk 306 includes a first axial side 314 and second opposite axial side 316. The first axial side 314 faces the first end cap 114.

The first axial side 314 has a circumferential ridge 320 projecting therefrom and spaced radially inboard from the outer rim 312. The first axial side 314 has seal surface 322 between the outer rim 312 and the ridge 320. The second axial side 316 also has a circumferential ridge 321 projecting therefrom and spaced radially inboard from the outer rim 312.

In this example embodiment, the valve member 304 further includes a plurality of ribs 326 on each of the first and second axial sides 314, 316 axially projecting from the first and second axial sides 314, 316 and radially extending from the through-opening 308.

In this embodiment, the first end cap 305 includes a tray 330 holding the filter media 110 and having an inner tray wall 332. A central hub 334 is in a first end cap opening 336. A plurality of spokes 338 extends between the hub 334 and the inner tray wall 332. An inlet arrangement 340, between the spokes 338, allows for fluid to be filtered to enter the cartridge 300 and into the filter interior 112.

The seal surface 322 of the first axial side 314 covers the inlet arrangement 340 to engage a terminal end of the inner tray wall 332 and forms a seal to prevent flow from the filter interior 112 and the unfiltered liquid volume 120. This will prevent cross-contamination to the clean side of the system during filter change-out. The valve 304 settles to the bottom of the cartridge 300 to substantially close the flow path 340 during service. By “substantially close”, it is meant that an intentional leak path is permitted to prevent excessive suction.

In this example, the rigid post 302 projects from the central hub 334 into the open filter interior 112. A terminal end of the rigid post 302 includes a radial projection 344 larger than the through opening 308 of the disk 306 to trap the disk 306 on the post 302. Many alternatives are possible.

In operation, fluid to be filtered enters the cartridge 300 through the inlet arrangement 340 and moves the valve member 304 away from sealing contact with the inner tray wall 332 of the first end cap 305. This allows the fluid to flow into the filter interior 112. During servicing, when flow through the cartridge 300 stops, the valve member 304 sinks to the bottom of the cartridge 300 to block the flow path 340.

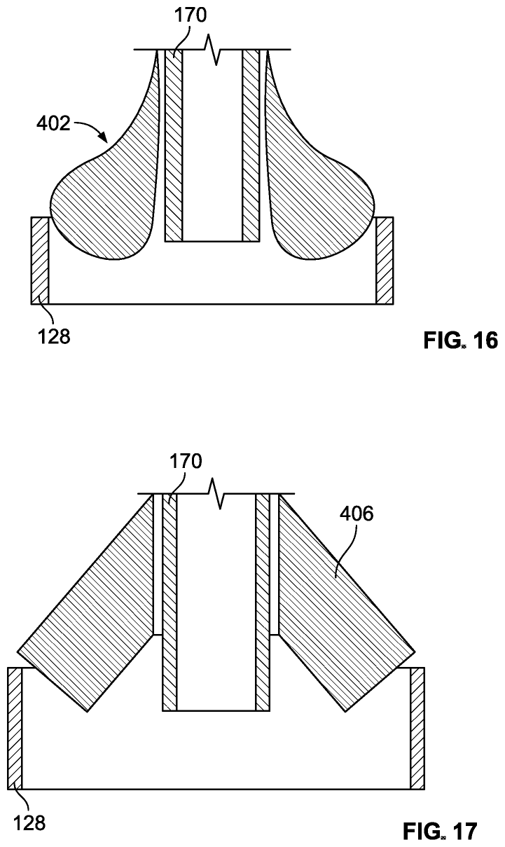

A variety of ways to provide a seal member on the valve member 200, 304 can be implemented, and the above are just examples. Further examples are shown in FIGS. 16-20.

A bulb seal 402 (FIG. 16) can be used. The bulb seal 402 may be secured to the valve surrounding wall 202. Alternatively, it can include a narrower opening to accommodate the post 302.

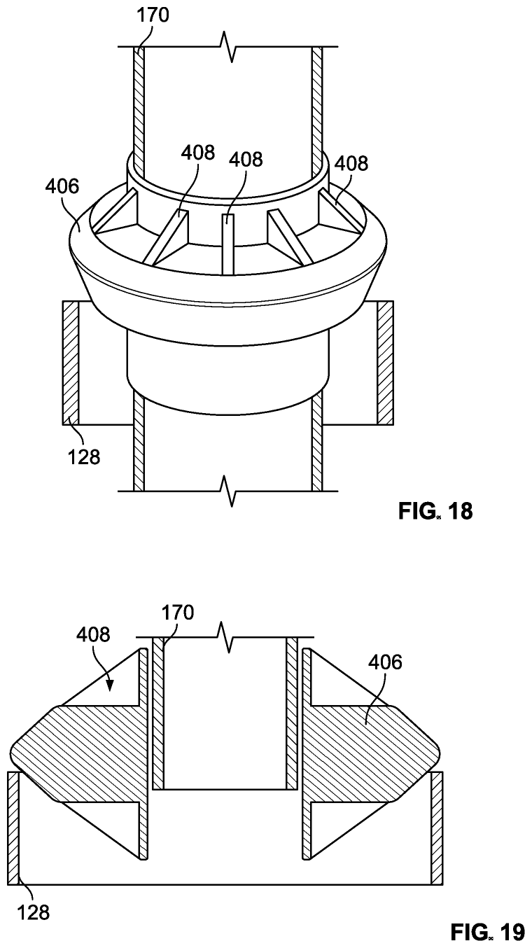

A wedge seal 406 (FIGS. 17-19) can be used. The wedge seal 406 can be secured to the surrounding wall 202. Alternatively, it can include a narrower opening to accommodate the post 302. There can be a plurality of ribs 408 (FIGS. 18 and 19) protruding from the wedge seal 406.

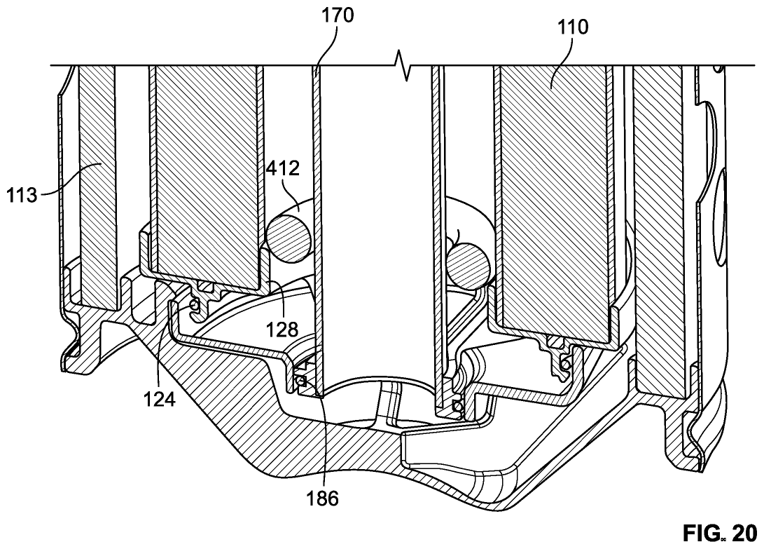

A torus shaped (i.e., ring or donut-shaped) seal 412 (FIG. 20) can be used. The torus shaped seal 412 may be secured to the valve surrounding wall 202. Alternatively, it can include a narrower opening to accommodate the post 302.

The above represents example principles. Many embodiments can be made using these principles.

1. A filter cartridge comprising:
(a) filter media arranged in a tubular shape defining an open filter interior, the filter media having first and second opposite ends;
(b) a first end cap secured to the first end of the filter media; the first end cap having an opening in communication within the open filter interior;
(c) a second end cap secured to the second end of the filter media;
(d) a central structure in the open filter interior extending away from the first end cap at least partially toward the second end cap; and
(e) an unbiased valve member within the open filter interior; the valve member being movable between a first position and a second position;
(i) the first position including the valve member covering the opening of the first end cap; and
(ii) the second position including the valve member being spaced from the first end cap to expose the opening of the first end cap.

2. The filter cartridge of claim 1 wherein the valve member has a surrounding wall defining a through opening.

3. The filter cartridge of claim 2 wherein the valve member is positioned to be radially constrained by the central structure,

4. The filter cartridge of claim 3 wherein the central structure rests within the through opening of the valve member.

5. The filter cartridge of claim 3 wherein the central structure comprises a flow tube having a tube wall and flow conduit within the tube wall; the flow tube extending to the second end cap.

6. The filter cartridge of claim 2 wherein the valve arrangement includes:
(a) first and second opposite valve ends; and
(b) a plate circumscribing and radially extending from the surrounding wall.

7. The filter cartridge of claim 6 wherein the plate is spaced from each of the first valve end and second valve end; and the plate has a first axial surface and an opposite second axial surface.

8. The filter cartridge of claim 6 wherein the plate is centered between the first valve end and the second valve end.

9. The filter cartridge of claim 7 further including a first plurality of gussets extending upward and radially away from the first valve end to the first axial surface.

10. The filter cartridge of claim 7 further including a second plurality of gussets extending downward and radially away from the second valve end to the second axial surface.

11. The filter cartridge of claim 2 wherein the valve arrangement has a bulb-shaped member extending from the surrounding wall.

12. The filter cartridge of claim 2 wherein the valve arrangement has a wedge-shaped member extending from the surrounding wall.

13. The filter cartridge of claim 12 further including a plurality of ribs extending from the wedge-shaped member to the surrounding wall.

14. The filter cartridge of claim 2 wherein the valve arrangement has a toms shaped member extending from the surrounding wall.

15. The filter cartridge of claim 4 further including:
(a) an inlet arrangement radially between an outer portion of the flow tube and an inner portion of the filter media.

16. The filter cartridge of claim 1 wherein the central structure comprises a rigid post.

17. The filter cartridge of claim 16 wherein the rigid post extends from the first end cap less than 50% of a length of the filter cartridge toward the second end cap.

18. The filter cartridge of claim 16 wherein the valve member comprises a non-porous disk having a through-opening; the rigid post being in intimate communication with the through-opening.

19. The filter cartridge of claim 18 wherein the disk includes:
(a) an outer rim; and
(b) a seal portion.

20. The filter cartridge of claim 19 wherein the disk includes:
(a) first and second opposite axial sides; the first axial side facing the first end cap;
(i) the first axial side having a circumferential ridge projecting therefrom and spaced radially inboard from the outer rim; and
(ii) the first axial side having a seal surface defining the seal portion between the outer rim and the ridge.

21. The filter cartridge of claim 20 further including a plurality of ribs on each of the first and second axial sides axially projecting from the first and second axial sides and radially extending from the through-opening.

22. The filter cartridge of claim 16 wherein the valve member includes any one of a bulb seal, wedge seal, or torus-shaped seal.

23. The filter cartridge of claim 18 wherein the first end cap includes:
(a) a tray holding the filter media and having an inner tray wall;
(b) a central hub in the first end cap opening; and
(c) plurality of spokes extending between the hub and the inner tray wall.

24. The filter cartridge of claim 23 wherein the rigid post projects from the central hub into the open filter interior.

25. The filter cartridge of claim 21 wherein:
(a) the first end cap includes a tray holding the filter media and having an inner tray wall; and
(b) the seal surface of the first axial side engages the inner tray wall.

26.-27. (canceled)

28. The filter cartridge of claim 1 further including a first seal member adjacent the first end cap; and wherein the second end cap has a second end cap seal member.

29.-34. (canceled)

35. The filter cartridge of claim 4 wherein the flow tube has a first end adjacent the first end cap; the first end of the flow tube including a flow tube seal member projecting radially therefrom.

36.-38. (canceled)

40. An in-tank filter assembly comprising:
(a) a tank; and
(b) a filter cartridge removably sealed within the tank; the filter cartridge comprising,
(i) filter media arranged in a tubular shape defining an open filter interior, the filter media having first and second opposite ends;
(ii) a first end cap secured to the first end of the filter media; the first end cap having an opening in communication within the open filter interior;
(iii) a second end cap secured to the second end of the filter media;
(iv) a central structure in the open filter interior extending away from the first end cap at least partially toward the second end cap; and
(v) an unbiased valve member within the open filter interior; the valve member being movable between a first position and a second position;
(A) the first position including the valve member covering the opening of the first end cap; and
(B) the second position including the valve member being spaced from the first end cap to expose the opening of the first end cap.
